(19) United States
(12) Patent Application Publication
(10) Pub. No.: US 2006/0054147 A1
(43) Pub. Date: Mar. 16, 2006

(54) Electric supercharging device for internal combustion engine

(75) Inventors: Akira Furukawa, Kariya-city (JP); Yuji Nakano, Toyota-city (JP); Shinji Ishida, Chiryu-city (JP); Ryo Sano, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/200,160

(22) Filed: Aug. 10, 2005

(30) Foreign Application Priority Data
Sep. 16, 2004 (JP) 2004-269506

(51) Int. Cl. F02B 33/00

(52) U.S. Cl. 123/565

(57) ABSTRACT

A supercharger includes a rotative member that is rotated by an electric motor eccentrically to the center of a casing. A valve is rotatably supported by a periphery of the rotative member. The valve is capable of making contact with a periphery of the rotative member so that an inner periphery of the casing and an outer periphery of the rotative member define an annular space therebetween in a full opening position. The valve is capable of making contact with the inner periphery of the casing to partition the annular space into multiple variable space in a full closing position. Opening degree of the valve is controlled in an intermediate position between the full closing position and the full opening position in accordance with an accelerator position in a low-load operation.

### CROSS REFERENCE TO RELATED APPLICATIONS

This application is based on and incorporates herein by reference Japanese Patent Application No. 2004-269506 filed on Sep. 16, 2004.

### FIELD OF THE INVENTION

The present invention relates to a supercharging device for an internal combustion engine, the supercharging device including a supercharger that is interposed in an intake pipe, the supercharger being electrically driven for pressurizing intake air, which is supplied into a combustion chamber of the engine.

### BACKGROUND OF THE INVENTION

A supercharging device disclosed in JP-A-2002-357127 includes a supercharger, an electric motor, and a supercharger controlling device. The supercharger is interposed in an intake pipe of an internal combustion engine for pressurizing intake air, which is supplied into a combustion chamber of the engine. The electric motor rotates the supercharger. The supercharger controlling device controls rotation speed of the supercharger in accordance with target intake pressure that is set on the basis of an operating condition of the engine. The electric motor drives the supercharger to supercharge intake air to increase torque and output power. The supercharger is rotated using suction power of the engine in a low-load operation, in which supercharging is not needed, so that fuel efficiency is enhanced.

However, in this supercharging device, a throttle body and a housing are provided to the intake pipe of the engine, in addition to the supercharger. The throttle body accommodates a throttle valve (THV), and the housing accommodates an idling speed control valve (ISCV). In particular, control components such as a throttle opening sensor need to be provided in an electrically controlled throttle valve. Accordingly, the number of components increases, therefore the supercharging device may be jumboized.

Furthermore, in the above supercharging device, response of charging pressure (actual pressure) with respect to a target pressure of the supercharger may be insufficient due to delay in response of the electric motor. Specifically, when the vehicle is quickly accelerated by stepping an accelerator pedal, for example, charging pressure does not quickly increase to the target pressure, which is set in accordance with an operating degree of the accelerator pedal.

Therefore, when a driver quickly accelerates the vehicle, delay arises in an actual amount of intake air with respect of a target amount of intake air. Specifically, delay arises in the actual amount of intake air, which is press-fed from the supercharger into the combustion chamber, with respect to the target amount of intake air, which is set in accordance with the operating degree of the accelerator pedal. Accordingly, delay arises in response of rotation speed of the engine, and the vehicle cannot be quickly accelerated corresponding to the operating degree of the accelerator pedal. As a result, drivability may be degraded.

Furthermore, when a wire harness, which connects the electric motor with the supercharger controlling device, breaks, or when the wire harness causes short circuit, the electric motor abnormally stops. When the electric motor abnormally stops, rotation of the supercharger stops, and a minimum amount of intake air cannot be press fed to the engine. In this situation, the engine may stop.

In view of the above problems, according to JP-A-2005-106275, a positive displacement pump (PD pump) shown in FIG. 8 is used as a supercharger. The PD pump includes a cylindrical casing and a rotor 102. The rotor 102 is eccentrically accommodated in the casing 101. The casing 101 has a suction port 103 and a discharge port 104 on the lower side thereof. The rotor 102 has an engaging portion 105 that engages with an output shaft of an electric motor, so that rotation of the output shaft is transmitted to the rotor 102. Four valves 106 are provided to the outer periphery of the rotor 102. Each valve 106 is in a curbed shape, and has a shaft. The casing 101 of the PD pump defines a circular cavity between the inner periphery of the casing 101 and the outer periphery of the rotor 102. The circular cavity of the PD pump is partitioned into four variable spaces 107 by the valves 106.

When the rotor 102 rotates, each valve 106 also rotates while the valve 106 is outwardly pulled by centrifugal force such that the rotor 102 makes contact with the inner periphery of the casing 101. In this situation, the inner volume of each variable space 107 repeats increasing and decreasing, so that air drawn into the variable space 107 is press-fed to the downstream side. Therefore, when the PD pump stops, the valve 106 rotates to the side of the outer periphery of the rotor 102 by negative pressure, so that a passage of intake air can be maintained, and thereby engine stall can be restricted.

When the engine is in an idling operation, or when engine load is low, an amount of intake air becomes small, and the engine need not be supercharged. In this situation, the rotor 102 is not rotated by an electric motor, and centrifugal pressure does not act to the valve 106 in the above structure. In this condition, the valve 106 sticks to the outer periphery of the rotor 102 due to negative pressure in an intake pipe on the downstream of the PD pump of the engine. Accordingly, the intake passage becomes in a full opening position. Thus, rotation speed of the engine may become excessively high due to increasing the amount of intake air.

### SUMMARY OF THE INVENTION

In view of the foregoing and other problems, it is an object of the present invention to provide a small sized supercharging device for an engine, the supercharging device including an electric supercharger that is capable of variably controlling an amount of intake air in accordance with an accelerator position when intake air need not be supercharged in one of a low-load operation and an idling operating condition.

It is another object of the present invention to provide an electric supercharger that includes valves, which make contact with the inner periphery of a casing for supercharging intake air in a high-load operation.

It is another object of the present invention to provide a supercharging device that includes an electric supercharger capable of reducing both delay in increasing charging pressure and delay in increasing rotation speed of the engine for enhancing drivability in an accelerating condition.

It is another object of the present invention to provide a supercharging device including an electric supercharger, which opens valves when charging pressure does not quickly increase, the electric supercharger being capable of reducing both delay in increasing of charging pressure and delay in rotation speed of the engine for enhancing drivability.

It is another object of the present invention to provide a supercharging device including an electric supercharger capable of restricting the engine from stopping when an internal electric motor fails.

According to one aspect of the present invention, a supercharger includes a casing, a rotative member, an electric motor, a plurality of valves, and an opening degree control means. The casing is interposed in an intake pipe of an internal combustion engine. The casing is in a substantially cylindrical shape. The rotative member is arranged eccentrically with respect to a center of the casing. The rotative member is rotatable relative to the casing. The electric motor rotates the rotative member at a predetermined rotation speed. The plurality of valves is rotatably supported by a periphery of the rotative member. The plurality of valves is capable of making contact with a periphery of the rotative member so that an inner periphery of the casing and an outer periphery of the rotative member are capable of defining an annular space therebetween. The plurality of valves is capable of making contact with the inner periphery of the casing to partition the annular space into a plurality of variable space. The opening degree control means switches the plurality of valves between a full closing position and a full opening position. The plurality of valves makes contact with the inner periphery of the casing in the full closing position. The plurality of valves makes contact with the periphery of the rotative member in the full opening position. The opening degree control means performs an intake air control in one of a low-load operation and an idling operation. Intake air need not be supercharged in the low-load operation and the idling operation. The opening degree control means switches the plurality of valves to an intermediate position between the full closing position and the full opening position in the intake air control. The opening degree control means controls opening degree of the plurality of valves in accordance with an accelerator position.

A method for controlling a supercharging device for an internal combustion engine includes flowing steps. A target amount of intake air is set corresponding to an accelerator position. A first motor is stopped in one of the low-load operation and the idling operation. Rotation angle of a second motor is controlled relatively to the first motor to control a position of a plurality of valves in a casing in accordance with the target amount of intake air in one of the low-load operation and the idling operation. A predetermined gap is defined between the plurality of valves and an inner periphery of the casing corresponding to the target amount of intake air in one of the low-load operation and the idling operation.

Alternatively, a method for controlling a supercharging device including an electric supercharger for an internal combustion engine includes flowing steps. Both target rotation speed of the electric supercharger and target charging pressure of the electric supercharger are set in accordance with an operating condition of the internal combustion engine. Both rotation speed of a first motor and rotation speed of a second motor are controlled in accordance with both the target rotation speed of the electric supercharger and the target charging pressure of the electric supercharger to rotate a plurality of valves in a casing for supercharging intake air. The first motor is stopped, and the second motor is rotated at a substantially constant rotation speed for moving the plurality of valves to be in a substantially full closing position using bias of a plurality of biasing means and turning force of the second motor relative to the first motor for defining an annular space between the plurality of valves and an inner periphery of the casing when actual pressure of the electric supercharger delays with respect to the target pressure of the electric supercharger.

The above method for controlling a supercharging device may further include following steps. Rotation of the first motor is started, and rotation speed of the first motor is increased to the target rotation speed of the electric supercharger after defining the annular space in the substantially full closing position. Rotation speed of the second motor is gradually decreased when rotation speed of the first motor becomes in the vicinity of the target rotation speed of the electric supercharger. The second motor is stopped when rotation speed of the first motor substantially coincides with the target rotation speed of the electric supercharger, after gradually decreasing rotation speed of the second motor.

Thereby, both delay in increasing charging pressure and delay in increasing rotation speed of the engine can be reduced, so that drivability can be enhanced.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a supercharging device for an internal combustion engine, according to a first embodiment of the present invention;

FIG. 2A is a cross sectional side view showing a condition, in which valves are closed in the supercharging device, and FIG. 2B is a cross sectional side view showing a condition, in which the valves are opened in the supercharging device, according to the first embodiment;

FIG. 3 is a perspective view showing the condition, in which the valves are closed in the supercharging device, according to the first embodiment;

FIG. 4 is a cross sectional front view showing the condition, in which the valves are closed in the supercharging device, according to the first embodiment;

FIG. 5 is a schematic view showing the supercharging device for the internal combustion engine, the valves being closed in the supercharging device, according to the first embodiment;

FIG. 6 is a perspective view showing the condition, in which the valves are opened in the supercharging device, according to the first embodiment;

FIG. 7 is a cross sectional front view showing the condition, in which the valves are opened in the supercharging device, according to the first embodiment; and

FIG. 8 is a cross sectional front view showing a positive displacement pump in which valves are opened, according to a prior art.

### DETAILED DESCRIPTION OF PREFERRED EMBODIMENTS

### First Embodiment

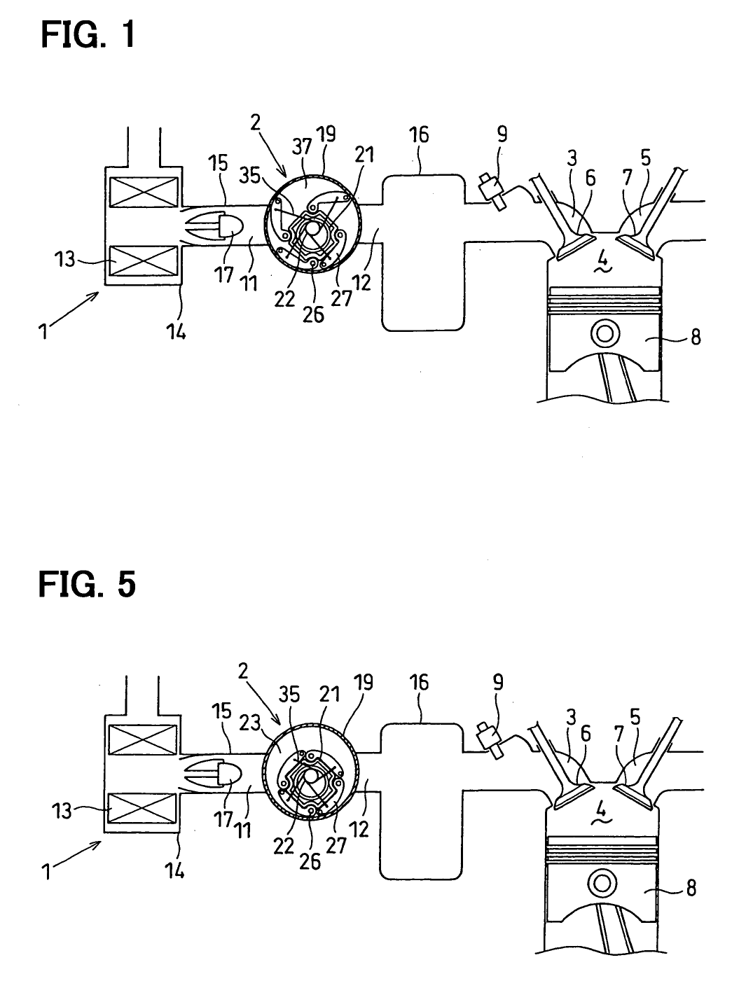

An internal combustion engine shown in FIGS. 1 and 5 is a supercharger engine. In this embodiment, the engine is a multicylinder 4-cycle gasoline engine, for example. The engine includes a supercharging device having an intake pipe 1, an electric supercharger 2, and the like. Intake air is supplied into the engine through the intake pipe 1. The supercharger 2 is interposed midway the intake pipe 1. The supercharger 2 has a structure, in which positions of valves are variable. The engine produces output power by generating thermal energy obtained by combustion of mixture gas in combustion chambers. The mixture gas includes intake air and fuel. The engine includes a cylinder head and a cylinder block. The cylinder head defines an intake port that airtightly connects with the downstream end of the intake pipe 1. The cylinder block defines the combustion chambers 4, into which mixture gas is drawn through intake ports 3. One side of the cylinder head defines the intake ports 3 that are respectively opened and closed by intake valves 6. The other side of the cylinder head defines exhaust ports 5 that are respectively opened and closed by exhaust valves 7.

The cylinder head and the cylinder block define cylinders therein. Each cylinder slidably accommodates a piston 8 that is connected with a crankshaft (engine output shaft, not shown) of the engine via a connecting rod (not shown). Sparkplugs are provided to the cylinder head such that each tip end of each sparkplug is exposed into the combustion chamber 4. An electric fuel injection valve (injector) 9 is provided to the cylinder head for injecting fuel to the wall surface of the intake port 3 or for injecting fuel to the behind wall surface of the intake valve 6. The engine is mounted with an electronically controlled fuel injection device that is constructed of various sensors, an engine control unit (electronic control unit, ECU) 200, and the like. The sensors detect various conditions such as a load condition of the engine and an operating condition of the vehicle. The ECU 200 integrates the detection signals of the sensors, and carries out controls in accordance with the detection signals. The fuel injection device has a system, in which an electric fuel pump (not shown) pressurizes fuel to be in a predetermined pressure, and feeds the fuel into the injectors 9 through a fuel filter (not shown), so that a predetermined amount of fuel can be injected at proper injection timings.

The intake pipe 1 defines an intake passages 11, 12 therein. The intake passage 11 is arranged upstream of the supercharger 2, so that intake air is introduced into the supercharger 2 through the intake passage 11. The intake passage 12 is arranged downstream of the supercharger 2, such that intake air is introduced into the combustion chambers 4 of the engine through the intake passage 12. The engine intake pipe 1 is constructed of an air cleaner 13, an intake duct 15, a surge tank 16, and an intake manifold (intake pipe, not shown). The air cleaner 13 filters intake air. The intake duct 15 is airtightly connected with the downstream end of a case 14 accommodating the air cleaner 13. The surge tank 16 is airtightly connected with the downstream end of the intake duct 15 through the supercharger 2 for absorbing pulsation of intake air. The intake pipe is airtightly connected with the downstream end of the surge tank 16. An air flowmeter 17 is provided in the intake duct 15 for detecting an amount of intake air.

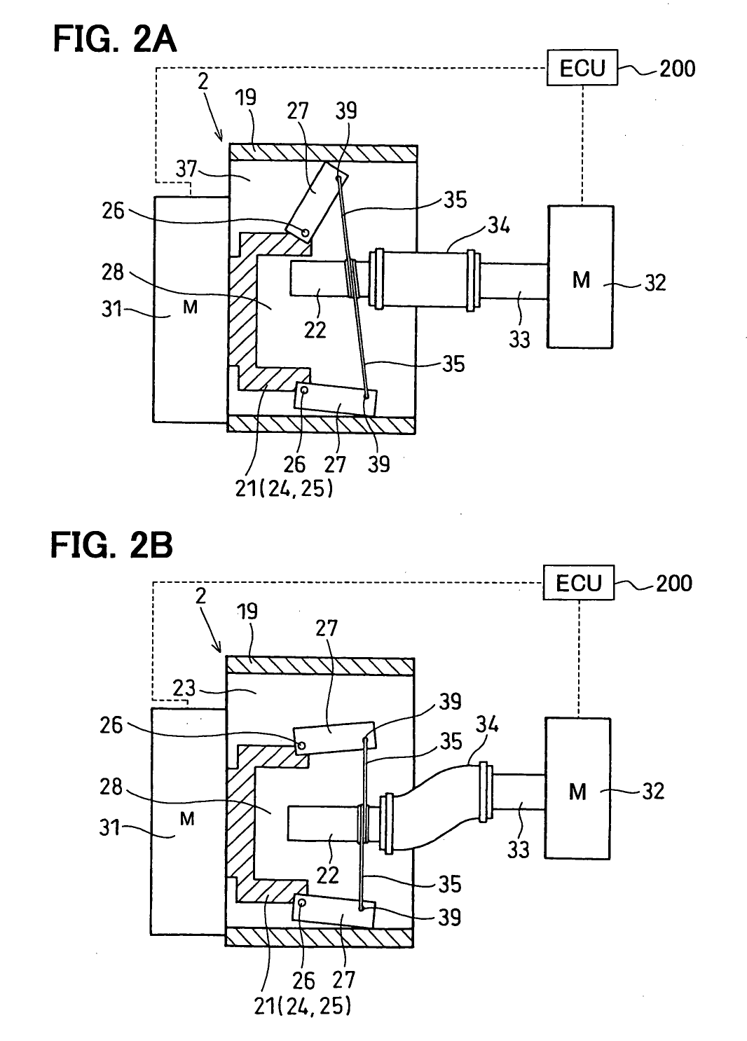

As referred to FIGS. 2 to 4, the supercharger 2 includes a casing 19, a rotative member, and a rotative member driver, in this embodiment. The casing 19 is interposed midway the intake pipe 1. The rotative member is rotatably provided in the casing 19 such that the rotation axis of the rotative member is eccentric with respect to the center of the casing 19. The rotative member driver rotates the rotative member at a predetermined rotation speed. The rotative member driver is divided into two components including a first rotor (first rotative member) 21 and a second rotor (second rotative member) 22. The first rotor 21 is in a substantially cylindrical shape. The first rotor 21 is rotatably accommodated in the casing 19. The first rotor 21 has the rotation axis that is eccentrically arranged with respect to the center of the casing 19. The second rotor 22 is capable of rotating integrally with the first rotor 21, and is capable of rotating relatively with respect to the first rotor 21.

The casing 19 is formed of a metallic material such as stainless steel to be in a substantially cylindrical shape. The casing 19 has one axial end in the cylindrical direction. The one axial end of the casing 19 is connected with a first plate (not shown) that is in a substantially disc shape. The casing 19 has the other axial end, to which a second plate (not shown) is connected. The second plate is in a substantially disc shape.

The first and second rotors 21, 22 are rotatably accommodated in the casing 19. An air inlet hole (not shown) is formed on one side of the casing 19 (on the upper left side in FIGS. 1, 5). Intake air is drawn into an annular space 23, which is formed between the inner periphery of the casing 19 and the outer periphery of the first rotor 21, through the air inlet hole. An air outlet hole (not shown) is formed on the other side of the casing 19 (on the right side in FIGS. 1, 5). Intake air is discharged from the annular space 23 through the air outlet hole.

The first rotor 21 is formed of a metallic material such as stainless steel to be in a predetermined shape. The first rotor 21 includes a substantially cylindrical rotor body 24, a substantially cylindrical valve holder 25, multiple pins (shafts) 26, and multiple valves (valve bodies) 27. The rotor body 24 has a rotation center that is eccentric with respective to the center of the casing 19, so that the rotor body 24 is rotatable eccentrically relative to the casing 19. The valve holder 25 is substantially oblong in cross section. The valve holder 25 engages with the outer periphery of the rotor body 24, so that the valve holder 25 integrally rotates with the rotor body 24. Each pin 26 is rotatably inserted into an engaging hole (not shown) formed in a shelf-shaped portion (outer periphery, not shown) protruding outwardly from each angular portion of the valve holder 25. Each valve 27 is rotatably supported by the pin 26.

The rotor body 24 and the valve holder 25 are integrated to be the first rotor 21. As referred to FIG. 2, the first rotor 21 has an engaging portion (not shown) that engages with the outer periphery of a driveshaft (first motor shaft, output shaft, not shown) of a first motor 31. The driveshaft of the first motor 31 has one end that is rotatably supported by a bearing (not shown) and a sealing member (not shown) that are provided to the first plate of the casing 19. The rotor body 24 defines a hollow space 28 that rotatably accommodates the second rotor 22 therein. Each angular portion of the valve holder 25 has a valve supporting portion 29 that is in a substantially arc shape, which substantially corresponds to a shape of one end portion of the valve 27. The one end portion of the valve 27 is in a substantially cylindrical shape.

The valve holder 25 has multiple substantially flat outer peripheries (accommodating portions). Each of the substantially flat outer peripheries is arranged between two angular portions that are circumferentially adjacent to each other in the valve holder 25. The substantially flat outer periphery of the valve holder 25 is capable of receiving each valve 27, when the valve 27 makes contact with the substantially flat outer periphery.

The second rotor 22 is formed of a metallic material such as stainless steel to be in a predetermined cylindrical shape or a column shape. The second rotor 22 engages with the inner periphery of the rotor body 24 of the first rotor 21 while defining a predetermined clearance therebetween, such that the second rotor 22 is capable of rotating relatively with respect to the first rotor 21.

As referred to FIGS. 2A, 2B, the second rotor 22 has one end, in which an engaging portion is formed. The engaging portion of the second rotor 22 engages with the outer periphery of the driveshaft (second motor shaft, output shaft) of a second motor 32 via a flexible joint 34. The end portion of the flexible joint 34 on the left side in FIGS. 2A, 2B is rotatably supported by a bearing (not shown) and a sealing member (not shown) that are provided to the second plate of the casing 19, and is movable vertically in FIGS. 2A, 2B. The outer periphery of the second rotor 22 has supporting portion that supports multiple springs 35 that are respectively wound around the outer periphery of the second rotor 22. The supporting portion of the second rotor 22 may define a hooking groove, to which the ends of the springs 35 respectively hook.

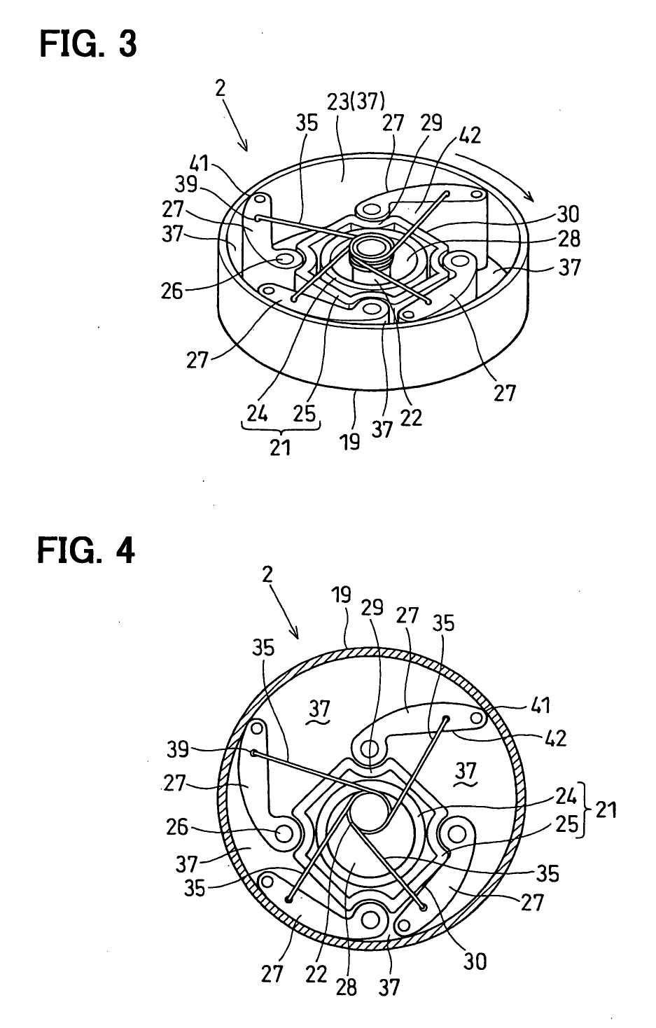

The valves 27 are formed of a metallic material such as stainless steel to be in a predetermined shape. Each valve 27 has the end portion (cylindrical portion) that engages with each pin 26 provided to the first rotor 21, so that the valve 27 is rotatably supported by the shelf-shaped portion (outer periphery) of the first rotor 21. Opening degree of the valves 27 is variable between a full opening position thereof and a full closing position thereof. Specifically, the valve 27 makes contact with an outer periphery 30 of the valve holder 25 of the first rotor 21, in the full opening position of the valve 27. Thereby, the annular space 23 is formed between the inner periphery of the casing 19 and both the outer periphery of the valve holder 25 of the first rotor 21 and the outer wall surfaces of the valves 27, in the full opening position. The valves 27 slidably make contact with the inner periphery of the casing 19, so that the valves 27 respectively partition the annular space 23 into multiple variable spaces 37, in the full closing position of the valve 27. As referred to FIGS. 3, 4, the valve 27 has a seat portion 41 on the outer sidewall surface of the other end portion of the valve 27. The seat portion 41 slidably makes contact with the inner periphery of the casing 19. The valve 27 has the inner sidewall surface that forms a contact portion 42, which makes contact with the outer periphery 30 of the valve holder 25 of the first rotor 21.

Each valve 27 connects to the first rotor 21 via each pin 26, and connects to the second rotor 22 via each spring 35. The valve 27 has the outer sidewall surface that is formed in a curved shape (arc shape) in cross section. When the valves 27 are switched to the full opening position, the outer shape of the rotative member, which is constructed of the first rotor 21 and the valves 27, becomes substantially circular. The one ends (cylindrical portions) of the valves 27 are respectively supported around the outer sidewall surface of the valve supporting portion 29 of the first rotor 21 such that the valves 27 are rotatable relative to the first rotor 21. Each of the one ends of the valves 27 and the outer sidewall surface of the valve supporting portion 29 define a predetermined clearance (gap) therebetween.

The supercharger 2 has an opening and closing positions switching means (opening degree control means) that switches the full closing position in a supercharging position, the full opening position in a full opening air intake position, and an intermediately opening position in an intake air variable position (valve opening closing control position).

The seat portion 41 of the valve 27 makes contact with the inner periphery of the casing 19 in the full closing position. By contrast, the contact portion 42 of the valve 27 makes contact with the outer periphery 30 of the first rotor 21 in the full opening position. The intermediately opening position is an intermediate position between the full closing position and the full opening position.

The opening degree control means includes the springs 35 and a valve driving means. The springs 35 respectively bias the valves 27 in the closing direction, in which the valves 27 closes to the full closing position. The valve driving means operates the valves 27 in the opening direction and the closing direction thereof using resilience of the springs 35 and rotation force of the first and second motors 31, 32.

The valve driving means is constructed of the first and second motors 31, 32. The first motor (first electric motor) 31 has operations of both a valve driving means and a rotative member driving means. This valve driving means moves the valves 27 in the closing direction via the first rotor 21 using bias of the springs 35. This rotative member driving means rotates the first rotor 21, the valves 27, the springs 35, and the second rotor 22 in the right-hand direction in FIG. 3. The second motor (second electric motor) 32 has operations of both a valve driving means and a rotative member driving means. This valve driving means moves the valves 27 in the opening direction, in which the valves 27 opens to the full opening position, via the second rotor 22 and the springs 35 using bias of the springs 35. This rotative member driving means rotates the second rotor 22, the springs 35, the valves 27, and the first rotor 21 in one of the right-hand direction and the left-hand direction in FIG. 3.

The first motor 31 is an actuator that is capable of rotating inner components constructed of the first rotor 21, the valves 27, the springs 35, and the second rotor 22 in the right-hand direction in FIG. 3, while the valves 27 are in the full closing position. The first motor 31 is a brushless motor including a rotor and a stator, for example. The rotor is integrated with a driveshaft, and the stator opposes to the outer circumferential periphery of the rotor. The rotor is mounted with a rotor core that includes a permanent magnet. The stator is provided with the stator core, to which a stator coil is wound around, and a yoke casing, which is magnetized by magnetism of the stator coil.

The second motor 32 is an actuator that is capable of rotating inner components constructed of the second rotor 22, the springs 35, the valves 27, and the first rotor 21 in the right-hand direction in FIG. 3, while the valves 27 are in the full opening position. The second motor 32 has an operation of a power generator, which charges a vehicular battery and supplies electricity to electric components, when the first motor 31 rotates the second rotor 22 via the first rotor 21. The second motor 32 is an AC motor such as a three-phase induction electromotor. The second motor 32 is constructed of a rotor and a stator. The rotor is integrated with a driveshaft 33. The stator opposes to the circumferential periphery of the rotor. The rotor is mounted with a rotor core that includes a permanent magnet. The stator is provided with the stator core, to which a three-phase stator coil is wound around.

A flexible joint such as a rubber hose 34 is provided between an engaging portion of the second rotor 22 and the driveshaft 33 of the second motor 32. The flexible joint 34 is capable of linearly reciprocating the second rotor 22 along an imaginary line that connects between a location around the center of the casing 19 and a location around the rotation axis of the first rotor 21. As referred to FIGS. 2A, 2B, the flexible joint 34 has one end that is fixed to the outer periphery of the tip end of the driveshaft 33 of the second motor 32 using a fasting member such as a band. The flexible joint 34 has the other end that is fixed to the outer periphery of the tip end of the engaging portion of the second rotor 22 using a fasting member such as a band.

Each spring 35 serves as a biasing means that biases the seat portion 41 of the valve 27 to the inner periphery of the casing. 19 in the closing direction of the valve 27. The spring 35 is formed of a metallic material such as a low-carbon steel wire rod, a high-carbon steel wire rod. Alternatively, the spring 35 is formed of a resilient member such as a non-metallic wire rod. The spring 35 has the one end that is wound around the outer periphery of the supporting portion of the second rotor 22 and fixed to the second rotor 22. The spring 35 has the other end that hooks to a hooking groove 39 provided to the end of each valve 27. The spring 35 has the length from the outer periphery of the hooking portion of the second rotor 22 to the hooking groove 39 of the valve 27. The lengths of the springs 35 are set to be substantially constant to uniformize resilience of the springs 35.

In this embodiment, the ECU 200 controls rotation speed of the first and second motors 31, 32 and opening degree of the valves 27 in accordance with the sensor signals output from the various sensors that detect the operating condition of the engine, such that the operating condition becomes substantially optimum. Intake air (compressed air) is supercharged using the supercharger 2, so that the amount of intake air is increased to enhance both engine power and fuel efficiency. The ECU 200 includes a microcomputer (supercharger control device, opening degree control means). This microcomputer includes a CPU, a memory such as a RAM and a ROM, an input circuit, an output circuit, a power circuit, and first and second motor driving circuits. The analog signals of the various sensors are converted to digital signals using an A/D converter, and these digital signals are input to the microcomputer.

The sensor signals include an intake air amount signal, an intake air temperature signal, an intake air pressure signal, a charging pressure signal, an accelerator position signal, and a crank angle signal. The intake air amount signal is transmitted from the air flowmeter (intake air flow sensor) 17. The intake air temperature signal is transmitted from an intake air temperature sensor (not shown). The intake air pressure signal and the charging pressure signal are transmitted from an intake air pressure sensor (not shown). The accelerator position signal is transmitted from an accelerator position sensor. The crank angle signal is transmitted from a crank angle sensor.

The air flowmeter 17 and the intake air temperature sensor are provided upstream of the supercharger 2 in the intake pipe 1. For example, the air flowmeter 17 and the intake air temperature sensor are arranged in the intake duct 15. The intake air pressure sensor is provided downstream of the supercharger 2 in the intake pipe 1. For example, the intake air pressure sensor is arranged in the surge tank 16. The microcomputer measures pulse intervals of the crank angle signal of the crank angle sensor to detect rotation speed of the engine.

The ECU 200 calculates a standard injection amount in accordance with the intake air amount signal of the air flowmeter 17 and rotation speed of the engine detected using the crank angle sensor. The ECU 200 corrects the standard injection amount using the sensor signals of the various sensors, so that the ECU 200 determines a command injection amount. The ECU 200 may directly calculate the standard injection amount in accordance with pressure in the intake pipe and rotation speed of the engine. Alternatively, the ECU 200 may indirectly calculate the amount of intake air in accordance with pressure in the intake pipe downstream of the supercharger 2 detected using the intake air pressure sensor and rotation speed of the engine. In this case, the air flowmeter 17 can be omitted.

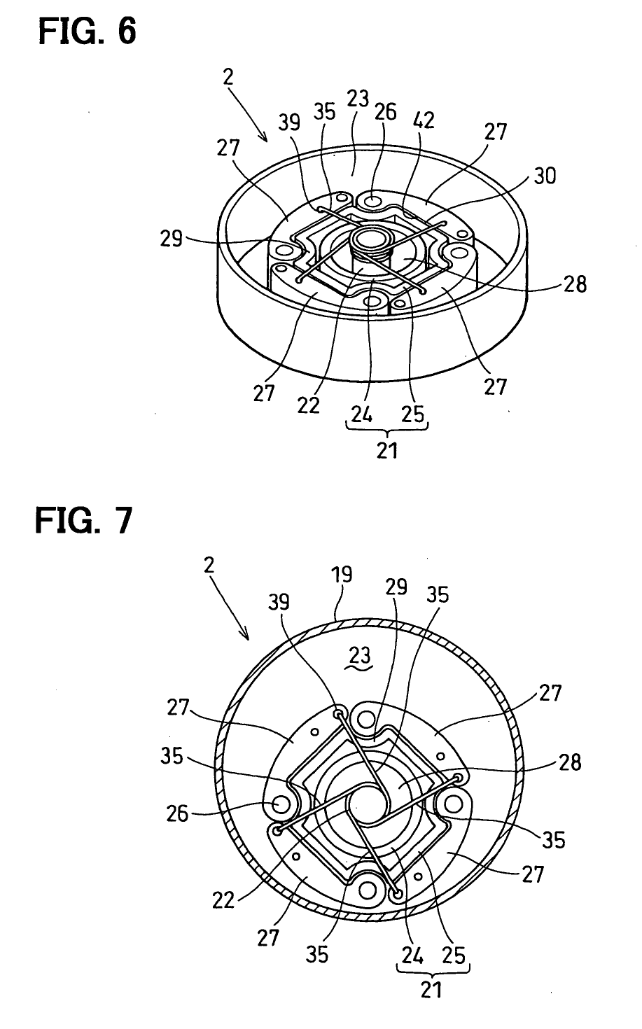

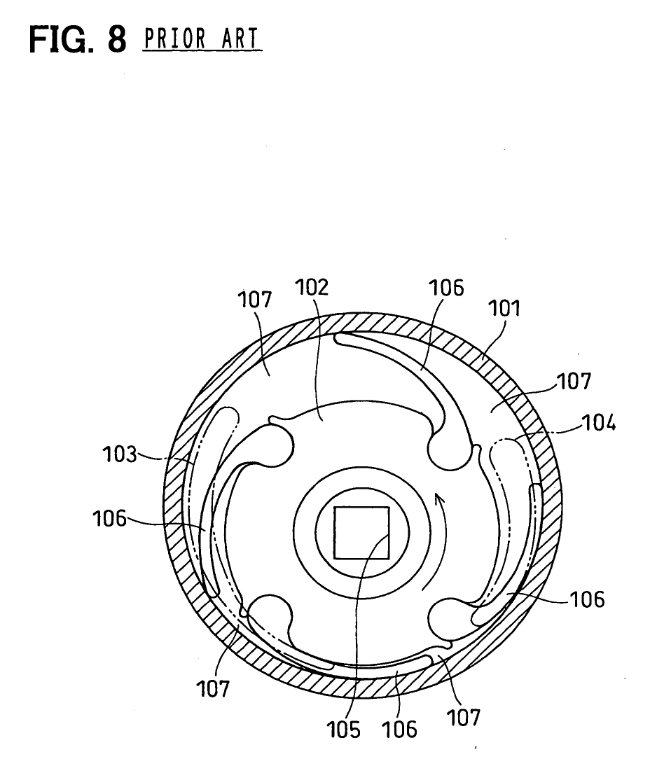

Next, an operation of the supercharging device in this embodiment is described in reference to FIGS. 1 to 7.

When the engine is in a low-load operation or in an idling operation, intake air need not be supercharged. Specifically, when operating degree of the accelerator position is small and rotation speed of the engine is low, the stator coil of the first motor 31 is de-energized. In this situation, electricity (supercharger driving electricity) supplied to the stator coil of the second motor 32 is controlled, and the second rotor 22 is rotated relatively to the first rotor 1, so that the valves 27 are operated in the opening direction thereof. Thereby, the valves 27 are operated to the intermediate position between the full closing position and the full opening position. Thus, the ECU 200 carries out a variable intake amount control, in which the opening degree of the valves 27 is variably controlled in accordance with the accelerator position and rotation speed of the engine. Alternatively, the supercharger driving electricity supplied to the stator coil of the second motor 32 may be controlled such that an actual relative rotation angle of the second motor 32 substantially coincides with a target relative rotation angle of the second motor 32 by calculating the target relative rotation angle in accordance with only the accelerator position operated by the driver.

In a suction stroke of the engine, the intake valves 6 are opened, and the exhaust valves 7 are closed. The piston 8 moves from the upper dead center to the lower dead center thereof, so that mixture gas is drawn into the combustion chamber 4 through the intake port 3. In this condition, intake air filtered through the air cleaner 13 is drawn into the annular space 23 in the supercharger 2 after flowing through the air flowmeter 17, the intake passage 11, and an inlet hole defined in the casing 19 of the supercharger 2. The intake air flowing into the annular space 23 passes through an outlet hole defined in the casing 19 into the intake passage 12 after flowing through the clearance (gap) defined between the inner periphery of the casing 19 and the valves 27. Thereby, intake air flowing out of the supercharger 2 approaches the intake port 3 of the engine after passing through the surge tank 16 and one of the intake manifold and the intake pipe. The intake air is mixed with fuel spray to be mixture gas in the intake port 3. The fuel spray is splayed from an injection hole of the injector 9. The mixture gas in the intake port 3 is drawn into the combustion chamber 4.

In a compression stroke of the engine, the intake valves 6 are closed. The piston 8 moves from the lower dead center toward the upper dead center thereof, so that mixture gas is compressed in the combustion chamber 4, while fuel atomized in the mixture gas is vaporized and mixed with air to be flammable gas. The piston 8 approaches the upper dead center, so that temperature and pressure of the mixture gas become high. The mixture gas is ignited by electric spark generated between electrodes of the sparkplug, so that the mixture gas quickly burns, and increases in pressure. The mixture gas presses the piston 8 to the lower dead center, so that the crankshaft of the engine is rotated in a combustion stroke. When the piston 8 substantially approaches the lower dead center, the exhaust valves 7 are opened, so that combustion gas is exhausted through the exhaust port of the engine, and the piston 8 moves to the upper dead center to exhaust combustion gas remaining in the combustion chamber 4 in an exhaust stroke. The engine performs the four strokes including the suction stroke, the compression stroke, the combustion stroke, and the exhaust stroke, within two rotations (720° C.A) of the crankshaft of the engine, in this embodiment.

When the engine is in a high-load operation, intake air needs to be supercharged. Specifically, when operating degree of the accelerator pedal is large, and rotation speed of the engine is high (or low), the ECU 200 calculates target charging pressure in accordance with the operating condition of the engine such as operating degree of the accelerator pedal. Specifically, the ECU 200 calculates the target charging pressure in accordance with the accelerator position and the rotation speed of the engine, for example. The ECU 200 detects pressure in the intake pipe as actual charging pressure using the intake pressure sensor. The ECU 200 calculates target rotation speed of the first motor 31 in accordance with deviation between the target charging pressure and the actual charging pressure in the intake pipe. The ECU 200 controls the supercharger driving electricity supplied to the stator coil of the first motor 31 such that actual rotation speed of the first motor 31 substantially coincides with the target rotation speed of the first motor 31.

When the engine is in a high-load operation, in which intake air needs to be supercharged, the stator coil of the second motor 32 is de-energized. In this situation, the first rotor 21 and the first motor 31 rotate the inner components constructed of the second rotor 22, the valves 27, the second motor 32, and the springs 35 in the right-hand direction (normal direction) in FIG. 3. Thereby, the springs 35, which are wound onto the outer periphery of the supporting portion of the second rotor 2, is relaxed, so that the valves 27 are rotated around the pins 26 by resilience of the springs 35, and pressed onto the inner periphery of the casing 19. The seat portions 41 of the valves 27 respectively make contact with the inner periphery of the casing 19 to the full closing position, in which the valves 27 partition the annular space 23 into the variable spaces 37.

Thus, the first rotor 21 and the first motor 31 rotate the inner components constructed of the second rotor 22, the valves 27, the second motor 32, and the springs 35, so that this inner components rotate while being in the full closing position. Thereby, a supercharging control is carried out such that rotation speed of the first motor 31 is controlled in accordance with the deviation between the target charging pressure and actual charging pressure in the intake pipe. Alternatively, the supercharger driving electricity supplied to the stator coil of the first motor 31 may be controlled such that actual rotation speed of the first motor 31 substantially coincides with the target rotation speed of the first motor 31, the target rotation speed of the first motor 31 being directly calculated in accordance with only the accelerator position, or both the accelerator position and rotation speed of the engine.

When the ECU 200 controls rotation speed of the driveshaft of the first motor 31, the drive shaft of the first motor 31 and the first rotor 21 rotates in the right-hand direction in FIG. 3. Thereby, as referred to FIGS. 1, 2A, and 4, the valves 27, the springs 35, and the second rotor 22 rotate integrally with the first rotor 21, so that the volumes of the variable spaces 37 respectively change. Specifically, the volumes of the variable spaces 37 repeatedly once increase, and subsequently decrease.

Intake air is drawn into one of the variable spaces 37 through the inlet hole defined in the casing 19. The intake air in the one of the variable spaces 37 is compressed through four strokes, which includes a suction stroke, a compression beginning stroke, a compression stroke, and a discharge stroke. The four strokes are carried out corresponding to rotation of the first and second rotors 21, 22 in the right-hand direction in FIG. 3. The intake air in the one of the variable spaces 37 is discharged from the outlet hole defined in the casing 19 to the intake passage 12 on the downstream side of the supercharger 2, after being compressed through the four strokes.

Thus, intake air flowing into the supercharger 2 is compressed by repeating change in the volumes of the variable spaces 37. Specifically, intake air is compressed in the supercharger 2 by repeating increasing and decreasing the volumes of the variable spaces 37, so that intake air is supercharged, and pressure in the intake pipe increases. Intake air is compressed in the supercharger 2, and discharged from the supercharger 2. The intake air approaches the intake port 3 of the engine after passing through the surge tank 16 and the one of the intake manifold and the intake pipe. The intake air in the intake port 3 is mixed with fuel splay injected through the injection hole of the injector 9 to be mixture gas, so that the mixture gas is drawn into the combustion chamber 4.

In a full accelerating operation (quickly accelerating operation), the driver quickly steps the accelerator pedal. In this full accelerating operation, actual charging pressure may not track to the target charging pressure due to delay in response of the first motor 31. In this situation, the ECU 200 de-energizes the stator coil of the first motor 31, and energizes the stator coil of the second motor 32, so that the ECU 200 rotates the second motor 32 at a constant rotation speed. When the driveshaft 33 of the second motor 32 rotates, the flexible joint 34 and the second rotor 22 rotates in the right-hand direction (normal direction) in FIG. 3 corresponding to the rotation of the driveshaft 33. Thereby, springs 35 are respectively further wound around the outer periphery of the supporting portion of the second rotor 22. Thus, the valves 27 are respectively rotated around the pins 26, and are pulled to the outer periphery 30 of the first rotor 21 by resilience of the springs 35. Thus, the valves 27 are switched to the full opening position such that the contact portions 42 of the valves 27 make contact with the outer periphery 30 of the first rotor 21 to form the annular space 23 in the supercharger 2.

Therefore, the second rotor 22 and the second motor 32 rotates inner components constructed of the springs 35, the valves 27, the first rotor 21, and the first motor 31, so that this inner components rotate while being in the full opening position shown in FIGS. 2B, 5, and 7. When this inner components starts rotation while being in the full opening position, the ECU 200 starts rotating the first rotor 21 by energizing the stator coil of the first motor 31, so that the ECU 200 increases rotation speed of the first motor 31 to the target rotation speed of the first motor 31.

When rotation speed of the first motor 31 approaches the target rotation speed of the first motor 31, the ECU 200 gradually decreases rotation speed of the second motor 32. When rotation speed of the first motor 31 substantially coincides with the target rotation speed of the first motor 31, the ECU 200 de-energizes the stator coil of the second motor 32. Thus, the first rotor 21 and the first motor 31 rotate the inner components constructed of the second rotor 22, the valves 27, the second motor 32, and the springs 35, so that this inner components rotate while being in the full closing position. Here, the target rotation speed of the first motor 31 is calculated in accordance with the deviation between the target charging pressure and the actual charging pressure.

Next, an operation, when the first motor 31 causes a failure, is described. The ECU 200 includes a first motor failure detecting means (first failure detecting means) that detects failure of the first motor 31. Specifically, the first failure detecting means detects an abnormal stop of the first motor 31 due to breaking or short circuiting of wiring in a wire harness that connects the first motor 31 with the first motor driving circuit of the ECU 200. When the ECU 200 detects abnormal stop due to failure arising in the first motor 31, the ECU 200 de-energizes the stator coil of the first motor 31, and the ECU 200 controls the supercharger driving electricity supplied to the stator coil of the second motor 32. Thereby, the ECU 200 rotates the second rotor 22 relative to the first rotor 21, so that the ECU 200 operates the valves 27 in the opening direction. Thus, the valves 27 are operated to the intermediate position between the full closing position and the full opening position.

The ECU 200 rotates the second motor 32 in the normal direction and the reverse direction to control the relative rotation angle of the second rotor 22 with respect to the first rotor 21 corresponding to the accelerator position and rotation speed of the engine. Thereby, the ECU 200 carries out the variable intake amount control, in which the ECU 200 controls opening degree of the valves 27, so that opening area of the clearance (gap) defined between the inner periphery of the casing 19 and the valves 27 is controlled.

Next, an operation, when the second motor 32 causes a failure, is described. The ECU 200 includes a second motor failure detecting means (second failure detecting means) that detects failure of the second motor 32. Specifically, the second failure detecting means detects an abnormal stop of the second motor 32 due to breaking or short circuiting of wiring in a wire harness that connects the second motor 32 with the second motor driving circuit of the ECU 200. When the ECU 200 detects abnormal stop due to failure arising in the second motor 32, the ECU 200 de-energizes the stator coil of the second motor 32, and the ECU 200 controls the supercharger driving electricity supplied to the stator coil of the first motor 31. Thereby, the ECU 200 rotates the first rotor 21 relative to the second rotor 22, so that the ECU 200 operates the valves 27 in the closing direction. Thus, the valves 27 are operated to the full closing position shown in FIGS. 1, 2A, and 4. The ECU 200 carries out the supercharging control, in which rotation speed of the first motor 31 is controlled in accordance with the deviation between the target charging pressure and actual charging pressure in the intake pipe, similarly to the high-load operation, in which intake air needs to be supercharged.

In this embodiment, as described above, the rotative member of the super charger 2 is driven using the two shafts in the supercharging device. Specifically, the first and second rotors 21, 22 respectively connect to the driveshaft 33 of the first and second motors 31, 32, so that the second rotor 22 is capable of reciprocating in the hollow space 28 of the first rotor 21.

In the full accelerating operation (quickly accelerating operation), the driver quickly steps the accelerator pedal, for example. In this situation, the valves 27 are switched to the full opening position such that the contact portions 42 of the valves 27 make contact with the outer periphery 30 of the first rotor 21. The springs 35 connect the second rotor 22 with the valves 27, and the lengths of the springs 35 are set to be substantially the same. Therefore, when the engine is in a high-load operation, in which intake air needs to be supercharged, predetermined tensile force (biasing force) is substantially uniformly applied to all the seat portions 41 of the valves 27. Therefore, all the seat portions 41 of the valves 27 substantially uniformly make contact with the inner periphery of the casing 19 in the full closing position.

The flexible joint 34 connects the engaging portion of the second rotor 22 with the driveshaft 33 of the second motor 32. The second rotor 22 is capable of linearly reciprocating along the imaginary line that connects between the location around the center of the casing 19 and the location around the rotation axis of the first rotor 21. The first rotor 21 and the first motor 31 rotate the inner components constructed of the second rotor 22, the valves 27, the second motor 32, and the springs 35, so that this inner components rotate while being in the full closing position shown in FIGS. 1, 2A, and 4. The second rotor 22 and the second motor 32 rotate inner components constructed of the springs 35, the valves 27, the first rotor 21, and the first motor 31, so that this inner components rotate while being in the full opening position shown in FIGS. 2B, 5, and 7.

The ECU 200 is capable of controlling the relative rotation angle of the second rotor 22 and the second motor 32 with respect to the first rotor 21 and the first motor 31 in the supercharger 2 in accordance with a target amount of intake air, while stopping the first rotor 21 and the first motor 31. The target amount of intake air is set corresponding to the operating condition of the engine. Thus, the ECU 200 is capable of controlling the amount of intake air, similarly to an operation in a structure, in which a throttle valve or an idling speed control valve are provided to an engine.

The ECU 200 carries out an opening degree control, in which the first rotor 21 is locked, and opening degree of the valves 27 is controlled using the second motor 32 when the engine is in a low-load operation or in an idling operation. In this condition, the contact portions 42 of the valves 27 are capable of being restricted from sticking onto the outer periphery 30 of the first rotor 21 due to negative pressure in the intake pipe. Therefore, the opening area of the intake passage in the annular space 23, which is formed between the inner periphery of the casing 19 and the outer periphery of the first rotor 21, can be restricted from being in a full opening position. Thus, a relatively small amount of intake air can be supplied into the combustion chambers 4 of the engine corresponding to the accelerator position. That is, the amount of intake air is capable of being controlled in accordance with the operation of the accelerator pedal, even when the engine does not include a throttle valve device having components such as a throttle body, a throttle valve, an idling speed control valve, and a throttle opening sensor. Thus, the number of components of a super charging device can be reduced, and the super charging device can be small sized.

When the engine is in a high-load operation, the operating condition of the engine is detected using the various sensors, so that the ECU 200 calculates a substantially optimum condition. The ECU 200 rotates the inner components using only the first motor 31 while the inner components are in the full closing condition. Thereby, intake air drawn into the combustion chambers 4 of the engine is capable of being supercharged. Thus, both fuel efficiency and output power can be enhanced, and the engine can be small sized. Here, the substantially optimum condition is the target rotation speed of the first motor 31 that is calculated in accordance with the deviation between the target charging pressure and the actual charging pressure, for example. Even when the intake passage 12 on the downstream of the supercharger 2 is in negative pressure, compressed air is capable of being steadily supplied into the combustion chambers 4 of the engine by providing the supercharger 2 in the intake pipe 1.

When the engine is in the full accelerating operation, delay may arise in response of the first motor 31, which rotates the inner components. In this situation, the control charging pressure (actual charging pressure) may not properly track to the target charging pressure, which is set corresponding to variation in the accelerator position. When the actual charging pressure does not properly track to the target charging pressure, the amount of intake air may not quickly increase, therefore rotation speed of the engine may not quickly increase. In this situation, the ECU 200 rotates the inner components in the supercharger 2 using only the second motor 32, while the inner components are in the full opening position. The opening area of the intake passage in the annular space 23, which is formed between the inner periphery of the casing 19 and the outer periphery of the first rotor 21, is set to be maximum in the full opening position. Therefore, intake air is drawn into the combustion chambers 4 of the engine through the annular space 23 in the supercharger 2 by negative pressure generated in the suction stroke, so that sufficient amount of intake air can be supplied for increasing rotation speed of the engine. Thus, both the amount of intake air and rotation speed of the engine can be restricted from delaying, even when response of the first motor 31 delays. Therefore, the vehicle can quickly accelerate corresponding to the accelerator position operated by the driver, so that drivability can be enhanced.

As described above, the ECU 200 rotates the second motor 32 to drive the inner components, which are in the full opening position in the supercharger 2. Subsequently, the ECU 200 energizes the first motor 31 to rotate the first motor 31.

When rotation speed of the first motor 21 increases to predetermined rotation speed, the ECU 200 can gradually decreases rotation speed of the second motor 32. In this situation, as rotation speed of the second motor 32 gradually decreases, the valves 27 gradually open to the full closing position. More specifically, the supercharger 2 can substantially constantly supply intake air while rotation speed of the first motor 21 increases, even when the opening area of the intake passage in the annular space 23 decreases by gradually closing the valves 27. Through this operation, the amount of intake air can be substantially constant before the supercharger 2 becomes to the full closing position, as rotation speed of the second motor 32 gradually decreases.

The ECU 200 gradually decreases rotation speed of the second motor 32, and when the inner components of the supercharger 2 becomes in the full closing position, the ECU 200 can de-energize the second motor 2. In this operation, the ECU 200 is capable of smoothly supercharging intake air flowing into the variable spaces 37 of the supercharger 2 without causing torque shock, as the volumes of the variable spaces 37 change.

The first motor 31 is used in the supercharging control in a normal condition. Even if the first motor 31 causes a failure, the ECU 200 carries out the opening degree control, in which the ECU 200 controls valves 27 using the second motor 32. Thus, the supercharger 2 is capable of supplying intake air into the combustion chambers 4 of the engine similarly to a throttle valve, so that the engine can be restricted from stopping. The supercharger 2 has a failsafe structure such that the driver is capable of evacuating the vehicle to a safe location in a limp form condition, so that a substantially normal operation of the vehicle can be maintained. The second motor 32 is used for switching the valves 27 from the full closing position to the full opening position. Even if the second motor 32 causes a failure, the first rotor 21 and the first motor 31 can rotate the inner components constructed of the second rotor 22, the valves 27, the second motor 32, and the springs 35, so that this inner components rotate while being in the full closing position. Therefore, the ECU 200 is capable of carrying out the supercharging control to supercharge intake air that flows into the combustion chambers 4 of the engine.

When the engine is in a high-load operation, the second motor 32 is turned OFF. In this high-load operation, the driveshaft 33 of the second motor 32 is rotated with the second rotor 22 and the flexible joint 34 by turning force of the first motor 31. Therefore, the second motor 32 serves as an electric generator for charging the vehicular battery and supplying electricity to electric components. That is, electric energy can be recovered using the second motor 32.

The springs 35 presses the seats 41 of the valves 27 onto the inner periphery of the casing 19 in the full closing position. In the above structure, tensile force (biasing force) of the springs 35 is substantially uniformized, so that contact portions between the inner periphery of the casing 19 and the seat portions 41 of the valves 27 can be protected from causing abnormal ablation.

In the above structure, the first motor 31 can perform two operations. Specifically, the first motor 31 operates the valves 27 in the closing direction using resilience of the springs 35, and rotates the inner components in the super charger 2. The second motor 32 can perform two operations. Specifically, the second motor 32 operates the valves 27 in the opening direction using resilience of the springs 35, and rotates the inner components in the super charger 2. Therefore, the number of components can be reduced in the above structure, compared with a structure, in which two of the first motors 31 and two of the second motors 32 are provided to satisfy the above two operations for each of the first and second motors 31, 32.

### Modified Embodiment

A pressure sensor and a torque sensor may be provided to the supercharger 2 to detect load resistance of the valves 27. The ECU may control the driveshaft 33 of the second motor 32 for controlling rotation of both the second rotor 22 and the flexible joint 34. In this structure, the supercharger can reduce load resistance to the minimum degree. The first motor may be separated into two motors including a first motor (rotative member driving means), which rotates only the first rotor 21, and a first motor (opening and closing positions switching means), which switches the valves 27 from the full opening position to the full closing position. The second motor may be separated into two motors including a second motor (rotative member driving means), which rotates only the second rotor 22, and a second motor (opening and closing positions switching means), which switches the valves 27 from the full closing position to the full opening position. The valves 27 may be switched from the full closing position to the full opening position when the engine is stopped or when the engine is started.

Actual charging pressure may not track the target pressure due to delay in response of the first motor 1 when the vehicle is accelerated. In this situation, the stator coil of the first motor 31 may be de-energized and electricity supplied to the stator coil of the second motor 32 may be controlled to switch the valves 27 from the full closing position to the full opening position, before a predetermined condition is satisfied. The predetermined condition may be satisfied after elapsing predetermined time from a time point, in which the valves 27 are switched to the full opening position, for example. Alternatively, the predetermined condition may be satisfied by eliminating deviation between the target charging pressure and the actual charging pressure.

The structures and methods of the above embodiments can be combined as appropriate.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A supercharger comprising:
a casing that is interposed in an intake pipe of an internal combustion engine, the casing being in a substantially cylindrical shape;
a rotative member that is arranged eccentrically with respect to a center of the casing, the rotative member being rotatable relative to the casing;
an electric motor that rotates the rotative member at a predetermined rotation speed;
a plurality of valves that is rotatably supported by a periphery of the rotative member, wherein the plurality of valves is capable of making contact with a periphery of the rotative member so that an inner periphery of the casing and an outer periphery of the rotative member are capable of defining an annular space therebetween, and the plurality of valves is capable of making contact with the inner periphery of the casing to partition the annular space into a plurality of variable space; and
an opening degree control means that switches the plurality of valves between a full closing position and a full opening position, wherein the plurality of valves makes contact with the inner periphery of the casing in the full closing position, and the plurality of valves makes contact with the periphery of the rotative member in the full opening position,
wherein the opening degree control means performs an intake air control in one of a low-load operation and an idling operation, wherein intake air need not be supercharged in the low-load operation and the idling operation,
wherein the opening degree control means switches the plurality of valves to an intermediate position between the full closing position and the full opening position in the intake air control, and
the opening degree control means controls opening degree of the plurality of valves in accordance with an accelerator position.

2. The electric supercharger according to claim 1,
wherein the opening degree control means performs a supercharging control in a high-load operation, in which intake air needs to be supercharged,
the opening degree control means switches the plurality of valves to the full closing position in the supercharging control, and
the opening degree control means controls rotation speed of the electric motor in accordance with the accelerator position in the supercharging control.

3. The electric supercharger according to claim 1,
wherein the rotative member is divided into a first rotative member and a second rotative member,
the first rotative member is rotatably accommodated in the casing,
wherein the first rotative member has a rotation axis, which is eccentric with respect to a center of the casing,
the second rotative member is capable of rotating integrally with the first rotative member,
the second rotative member is capable of rotating relatively to the first rotative member,
the first rotative member defines a hollow space therein,
the second rotative member is capable of moving in the hollow space of the first rotative member, and
the second rotative member is at least partially accommodated rotatably in the hollow space of the first rotative member.

4. The electric supercharger according to claim 3,
wherein the electric motor includes a first motor and a second motor,
the first motor connects with the first rotative member,
the first motor is capable of rotating the plurality of valves and the second rotative member via the first rotative member,
the second motor connects with the second rotative member, and
the second motor is capable of rotating the plurality of valves and the first rotative member via the second rotative member.

5. The electric supercharger according to claim 4,
wherein the opening degree control means includes a plurality of biasing means and a valve driving means,
the plurality of biasing means biases the plurality of valves in a closing direction, and
the valve driving means is capable of moving the plurality of valves in both an opening direction and a closing direction using bias of the plurality of biasing means and turning force of both the first motor and the second motor.

6. The electric supercharger according to claim 5,
wherein the periphery of the first rotative member has a plurality of shafts that rotatably supports the plurality of valves,
each of the plurality of biasing means is a resilient member formed of one of metallic wire and non-metallic wire,
the plurality of valves connects with the first rotative member via the plurality of shafts, and
the plurality of valves connects with the second rotative member via the plurality of biasing means.

7. The electric supercharger according to claim 6,
wherein the plurality of biasing means is wound around an outer periphery of the second rotative member,
the plurality of biasing means respectively has lengths from the outer periphery of the second rotative member to the plurality of the valves, and
the lengths of the plurality of biasing means are substantially equivalent to each other, so that bias of the biasing means is substantially constant.

8. The electric supercharger according to claim 5,
wherein the valve driving means includes the first motor and the second motor,
the first motor is capable of performing both a closing operation and a first rotating operation,
the first motor operates the plurality of valves in a closing direction via the first rotative member using bias of the plurality of biasing means in the closing operation,
the first motor rotates the first rotative member in the first rotating operation,
the second motor is capable of performing both an opening operation and a second rotating operation,
the second motor operates the plurality of valves in an opening direction via the second rotative member using bias of the plurality of biasing means in the opening operation, and
the second motor rotates the second rotative member in the second rotating operation.

9. The electric supercharger according to claim 8, further comprising:
a flexible joint that is arranged between the second motor and the second rotative member,
wherein the flexible joint is capable of substantially linearly reciprocating the second rotative member along an imaginary line that connects between a location around the center of the casing and a location around the rotation axis of the first rotative member.

10. The electric supercharger according to claim 8,
wherein the second motor is an electric generator that generates electricity when the plurality of valves and the second rotative member are rotated using the first motor via the first rotative member in the supercharging control,
the second motor supplies electricity for charging a vehicular battery in the supercharging control, and
the second motor supplies electricity to electric components in the supercharging control.

11. A supercharging device for the internal combustion engine, the supercharging device including the electric supercharger according to claim 8, the supercharging device comprising:
a supercharger control device that sets a target amount of intake air corresponding to an accelerator position, the supercharger control device controlling rotation angle of the second motor in accordance with the target amount of intake air,
wherein the supercharger control device stops the first motor in one of the low-load operation and the idling operation, wherein intake air need not be supercharged in the low-load operation and the idling operation, and
the supercharger control device operates the second motor such that the plurality of valves and the inner periphery of the casing define a predetermined gap therebetween corresponding to the target amount of intake air in one of the low-load operation and the idling operation.

12. A supercharging device for the internal combustion engine, the supercharging device including the electric supercharger according to claim 8, the supercharging device comprising:
a supercharger control device that sets both target rotation speed of the electric supercharger and target charging pressure of the electric supercharger corresponding to an operating condition of the internal combustion engine,
wherein the supercharger control device controls both rotation speed of the first motor and rotation speed of the second motor in accordance with the target rotation speed of the electric supercharger and the target charging pressure of the electric supercharger,
when a driver demands acceleration or when actual pressure delays with respect to the target pressure of the electric supercharger due to delay in response of the first motor, the supercharger control device stops the first motor and rotates the second motor at a substantially constant rotation speed, subsequently the supercharger control device starts rotation of the first motor and increases rotation speed of the first motor to the target rotation speed of the electric supercharger, and
when rotation speed of the first motor becomes in the vicinity of the target rotation speed of the electric supercharger, the supercharger control device gradually decreases rotation speed of the second motor, subsequently the supercharger control device stops the second motor when rotation speed of the first motor substantially coincides with the target rotation speed of the electric supercharger.

13. The supercharging device according to claim 11,
wherein the supercharger control device includes a first failure detecting means and a second failure detecting means,
the first failure detecting means is capable of detecting failure of the first motor,
the second failure detecting means is capable of detecting failure of the second motor,
when the first failure detecting means detects failure arising in the first motor, the supercharger control device stops the first motor and operates only the second motor, and
when the second failure detecting means detects failure arising in the second motor, the supercharger control device stops the second motor and operates only the first motor.

14. A method for controlling a supercharging device for an internal combustion engine, the method comprising:
setting a target amount of intake air corresponding to an accelerator position;
stopping a first motor in one of the low-load operation and the idling operation;
controlling rotation angle of a second motor relatively to the first motor to control a position of a plurality of valves in a casing in accordance with the target amount of intake air in one of the low-load operation and the idling operation; and
defining a predetermined gap between the plurality of valves and an inner periphery of the casing corresponding to the target amount of intake air in one of the low-load operation and the idling operation.

15. A method for controlling a supercharging device for an internal combustion engine, the supercharging device including an electric supercharger, the method comprising:
setting both target rotation speed of the electric supercharger and target charging pressure of the electric supercharger in accordance with an operating condition of the internal combustion engine;
controlling both rotation speed of a first motor and rotation speed of a second motor in accordance with both the target rotation speed of the electric supercharger and the target charging pressure of the electric supercharger to rotate a plurality of valves in a casing for supercharging intake air; and
stopping the first motor and rotating the second motor at a substantially constant rotation speed for moving the plurality of valves to be in a substantially full closing position using bias of a plurality of biasing means and turning force of the second motor relative to the first motor for defining an annular space between the plurality of valves and an inner periphery of the casing when actual pressure of the electric supercharger delays with respect to the target pressure of the electric supercharger.

16. The method according to claim 15, further comprising:
starting rotation of the first motor and increasing rotation speed of the first motor to the target rotation speed of the electric supercharger after defining the annular space in the substantially full closing position;
gradually decreasing rotation speed of the second motor when rotation speed of the first motor becomes in the vicinity of the target rotation speed of the electric supercharger; and
stopping the second motor when rotation speed of the first motor substantially coincides with the target rotation speed of the electric supercharger, after gradually decreasing rotation speed of the second motor.

17. The method according to claim 14, further comprising:
detecting failure arising in the first motor and failure arising in the second motor;
stopping the first motor and operating only the second motor when failure is detected in the first motor; and
stopping the second motor and operating only the first motor when failure is detected in the second motor.
